(19) United States
(12) Patent Application Publication
(10) Pub. No.: US 2014/0099500 A1
(43) Pub. Date: Apr. 10, 2014

(54) COMPOSITE MATERIALS AND ARTICLES COMPRISING THE SAME

(71) Applicant: Danu CHOTIKAPANICH, (US)

(72) Inventors: Pierre Olivier Schnerb, Chonburi (TH); Paolo Cecchetti, Chonburi (TH); Phassutha Moonphukdi, Chonburi (TH)

(73) Assignee: Danu Chotikapanich, Chonburi (TH)

(21) Appl. No.: 14/123,124

(22) PCT Filed: May 31, 2011
(86) PCT No.: PCT/TH2011/000018

§ 371 Date: Nov. 29, 2013

(51) Int. Cl. B32B 9/04; B32B 27/12; B63B 35/79; B32B 5/18

(52) U.S. Cl. CPC B32B 9/047; B32B 5/18; B32B 27/12; B63B 35/7909
USPC 428/332; 428/438; 428/423.1; 441/74

(57) ABSTRACT

The present invention disclosed a composite material comprising a core (10) sandwiched between two skins (15). Each of the skin (15) is a multiple layers skin comprising at least one layer of random discontinuous natural fiber sandwiched between layers of resin (25, 25″), glass fiber layers (30, 30″).

### BACKGROUND OF THE INVENTION

This invention relate to a composite material, more specifically a sandwich structured composite for use in manufacturing of water sport articles.

Composite material such as a sandwich structured composite has a wide range of industrial and recreational applications. The sandwich structure composite material is well known for their superior strength and is fabricated by attaching two thin but stiff skins to a thick light weight core. The skin is usually made of reinforced glass or carbon fiber while the core is usually made of polyvinylchloride, polyurethane, polyethylene or polystyrene foams, balsa wood. Honeycomb core is also common.

German Patent Application No. 102008047408 disclosed a sliding board comprising a core, an upper flange and a bottom flange with an upper base and a bottom base. The upper base and the bottom base are permanently connected by multiple vertical running flexible connecting elements. The connecting elements are formed as glass fiber, carbon fiber, textile fiber, natural fiber, particularly bamboo fiber or as flexible, metallic connection. The core consists of plastic, textile, aluminum or wood or mixture of these materials. The metallic layer consists of a titanium alloy, particularly titanal.

International Patent Publication No. WO 9510447 disclosed a chest-type surfboard comprises a plurality of elongate members extruded from expanded polyethylene structural foam. The members are joined laterally to one another by means of a thermal fusion bonding process which compacts the expand polyethylene. A thermally laminated skin is disposed on both upper and lower surface of the joined member forming a sandwich assembly.

While various attempts including the above discussed patent documents aim at improving strength of the article when expose to tension, compression or stress, those attempts often complicate and tricky to fabricate and often are more expensive. Therefore, it is an object of the present invention to provide alternative structure of a composite material that is not only provides excellent strength, but also create unique visual appeals and is easy and cheaper to fabricate.

### SUMMARY OF THE INVENTION

The invention disclosed a composite material more specifically a sandwich structured composite comprising a core sandwich between two skins. Each skin is a multiple layers skin comprising at least one layer of natural fiber sandwiched between layers of resin, glass fiber and adhesive.

In one embodiment of the invention, the composite material comprising a light weight core made of expanded polystyrene sandwiched between two skins. Each skin layer comprising at least one layer of random discontinuous coconut fiber sandwiched between resin, glass fiber and adhesive layers. The core defines a shape of water sport article such as a surfboard, a kite board or a stand up paddle-board. The skins are bonded to the core by means of vacuum press to completely enclosing the core.

### BRIEF DESCRIPTION OF DRAWINGS

The accompanying drawings illustrate embodiments of the principles described herein and are a part of the specification. The illustrated embodiments are merely examples and do not limit the scope of the claims, in which

FIG. 1 shows a cross section of a composite material according to the principle of the present invention;

FIG. 2 shows a cross section of another embodiment of the composite materials according to the principle of the present invention;

FIG. 3 shows an embodiment of a multiple layer skin according to the principle of the present invention;

FIG. 4 shows an embodiment of the composite material according to the principle of the invention defining a shape of a surfboard.

### DETAIL DESCRIPTION OF AN EMBODIMENT OF THE INVENTION

The present invention disclosed a composite material, more specifically a sandwich structured composite comprising a core 10 sandwiched between two skins 15.

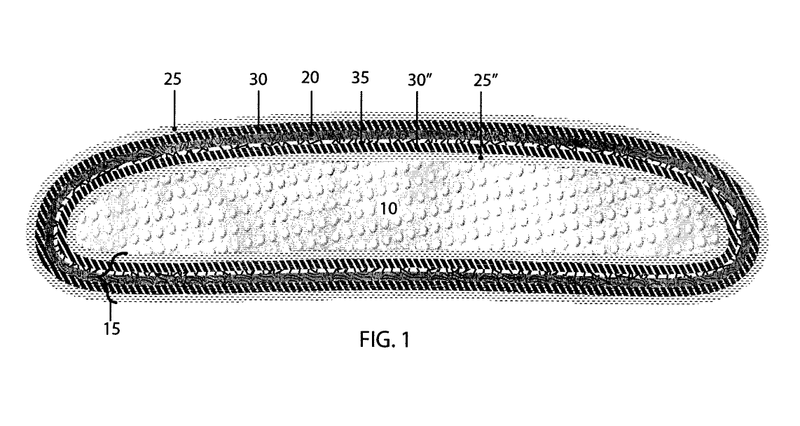

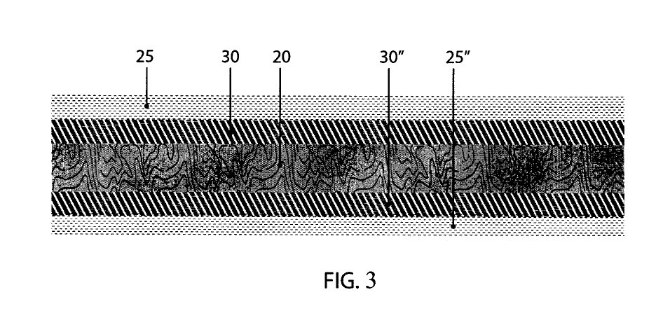

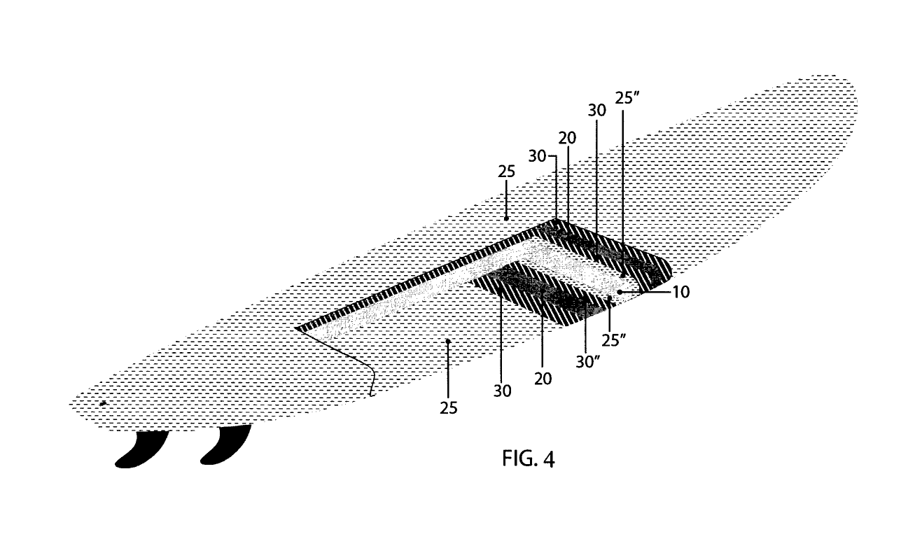

In one embodiment, the core 10 is made of a light weight material such as expanded polystyrene (EPS), polyurethane or any other EPS composite and is prepared as generally known in the art. The core (10) defines a shape and configuration of water sports article such as a surfboard, a kite board or a stand up paddle-board. As an example, as shown in FIGS. 1, 3 and 4, the core 10 defines a shape and configuration of a surfboard. The core 10 is enclosed between two skins 15. The skin 15 is a multiple layers skin characterized in that the skin 15 comprising at least one random and discontinuous natural fiber layer 20, preferably coconut fiber, sandwiched between layers of clear resin layers 25, 25″, synthetic fiber such as glass fiber layers 30, 30″ and an adhesive layer 35. More specifically, as shown in FIG. 3, the multiple layers skin 10 comprising at least a first layer of resin 25, a first layer of glass fiber 30, an adhesive layer 35, a natural fiber layer 20, a second layer of glass fiber 30″ and a second layer of resin 25″ arrange in a described sequence. The skin 15 is bonded onto the core 10 by means of vacuum pressing. For a better bonding of the skin 15 onto the core 10, the core 10 may be optionally pre-encased (mummified) with a layer of glass fiber.

For the purposes of explanation and to assist with understanding of the principles of the invention described herein, the description will be made in reference to the accompanying drawings of embodiments of the invention in which a surfboard is used as an exemplary example.

A core 10 defining a shape and configuration of a surfboard and is made of a light weight materials such as expanded polystyrene (EPS), polyurethane or any other EPS composite is prepared as generally known in the art. Furthermore, the core 10 is prepared with an optimum thickness as generally known in the art in order for the surfboard to be able to withstand shear stress. In addition, in order to improve bonding between the core 10 and the skin 15, the core 10 is optionally mummified with at least one layer of glass fiber.

In preparation of the skin 15, a first layer of glass fiber 30 having a layer of random and discontinuous natural fiber layer 20 deposited thereon is prepared in advance. This is achieved by providing a first layer of glass fiber 30 comprising at least one sheet of glass fiber having an outline shape and configuration of the surfboard. The said first layer of glass fiber 30 should be prepared to correspond to the size of the core 10 such that once the said first layer of glass fiber 30 is assembled to the core 10, a half of the core 10 which will form a deck of the surfboard is completely covered. Adhesive, preferably spray-type adhesive is then evenly applied onto the said first layer of glass fiber 30 forming the adhesive layer 35. Random, discontinuous coconut fibers, pre-extracted from coconut husk, are then thinly and evenly arranged onto the first layer of glass fiber 30 having adhesive applied thereon forming the natural fiber layer 20. The preassembled first layer of glass fiber 30, adhesive layer 35 and the natural fiber layer 20 is subsequently laid face down onto a second layer of glass fiber 30″, of which comprising at least one sheet of glass fiber, wetted with a second layer of resin 25″.

Preferably, in order to obtain optimum strength such that the surfboard able to withstand tension and compression, the natural fiber layer 20 should have a thickness of around 1.5 to 3 mm. In addition, the coconut fiber is strategically arranged randomly to create random orientation of the fiber strand in order to enhance strength of the skin 15 as well as to create a unique visual appeal to the surfboard. As an alternative, the random, discontinuous natural fiber may be pre-made as a natural fiber sheet, for example, coconut fiber sheet, so that the coconut fiber sheet may be easily applied on to the adhesive layer 35 deposited onto the first layer of glass fiber 30. The glass fiber sheet may also be prepared as a self-adhesive.

In assembling of the surfboard, the second layer of glass fiber 30″ is formed by providing at least one sheet of glass fiber on top of a first half of a mold forming a layer of the skin 10. The said second layer of glass fiber 30″ is wetted with clear resin deriving the second layer of resin 25″. The resin is evenly distributed throughout the said second layer glass fiber 30″. Application of resin onto the second layer of glass fiber 30″ should be done with care to avoid formation of air-pocket. The pre-assembled first layer of glass fiber 25 having the natural fiber layer 20 deposited thereon is laid face down onto the second layer glass fiber 30″. A layer of resin, forming a first layer of resin 25, is applied onto the faced down first layer glass fiber 30, forming completed one of the two skins 15. The core 10 which is optionally mummified with at least one layer of glass fiber, is then placed on top of the formed skin 15. Another skin 15 is then formed on the expose side of the core 10 by repeating the above described steps. During the formation of the latter skin 15, the pre-assemble glass fiber layer 25 having the natural fiber layer 20 deposited thereon, however, is laid face up. At the completion of the formation of the last skin 15, a second half of the mold is placed on top of the formed skin 15. The formed second half mold-skin-core-skin-first half mold is then subjected to vacuum press setting until the resin is cured. As the resin is cured under vacuum press, the skins 15 are tightly bonded to the core 15. The edge of the two skins 15 also met and completely fused together encasing the core 10 inside both skins 15. After curing time has lapsed, the mold is removed. The edges of two skins 15 are trimmed and the formed surfboard is then subject to further customary steps and finishes as desired.

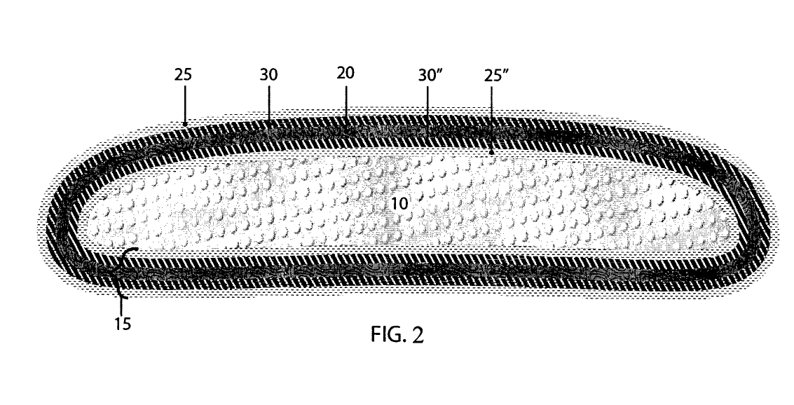

In another embodiment, as shown in FIG. 2, the composite material with the multiple layer skin without the adhesive layer is also possible. The adhesive layer 35, therefore, is not an essential element of the invention. The purpose of the adhesive is to hold loose coconut fiber onto the glass fiber sheet during the formation of the skin 15. Therefore, in an embodiment in which the coconut fiber in a form of a coconut fiber sheet is used, using adhesive is no longer a necessity. In addition, during the formation of the skin, although it is less convenience, the lose coconut fiber may be deposited directly onto the glass fiber sheet without the use of adhesive. Thus, utilization of adhesive layer 35 is only optional.

As described, once the resin is cured, the resin and the glass fiber layers became translucent enabling the coconut fiber layer sandwiched between them becomes visible. The random disconnected coconut fiber not only enhance strength of the surfboard, but such random and disconnected fiber also creates a unique visual appeal difficult to be found with other kind of synthetic or natural fibers. The random arrangement of the fiber strand creates fun and exciting as well as earthy and green appeal to the customer. Natural fiber, more specifically, coconut fiber also proves to be a cheap and efficient alternative fiber as coconut husk is commonly found. It is also very easy to fabricate. In addition, the process of extracting the fiber is very simple and is also environmentally friendly as the fiber needs no or very little treatment in comparison to other kinds of fiber such as synthetic fibers. The fun exciting pattern creates by the coconut fiber cut the usual customary finish steps to make the surfboard more attractive or appealing to the customer. Thus, lowering production hours and production cost. Thereby, composite material comprising coconut fiber sandwiched between multiple layers skin composite achieved the aforementioned object of the invention.

1. Composite material comprising a core (10) sandwiched between two skins (15), characterized in that each of the skin (15) is a multiple layers skin comprising at least one layer of natural fiber sandwiched between layers of resin (25, 25″), glass fiber layers (30, 30″).

2. The composite material according to claim 1 wherein the said at least one layer of natural fiber is a random, discontinuous coconut fiber layer (20).

3. The composite material according to claim 1 further comprising an adhesive layer 35 impregnate between the glass fiber layer (30 or 30″) and natural fiber layer and/or coconut fiber layer (20).

4. The composite material according to claim 1 wherein the core (10) is a light weight core (10) made of expanded polystyrene or polyurethane or expanded polystyrene composite.

5. The composite material according to claim 1 wherein the multiple layers skin (15) comprising at least a first layer of resin (25), a first layer of glass fiber (30), an adhesive layer (35), a coconut fiber layer (20), a second layer of glass fiber (30″) and a second layer of resin (25″) arrange in a sequence.

6. The composite material according to claim 3 wherein the random, discontinuous coconut fiber layer (20) is a coconut fiber sheet.

7. The composite material according to claim 3 wherein the coconut fiber layer is 1.5-3 mm. thick.

8. The composite material according to claim 4 wherein the core (10) is optionally mummified with at least one layer of glass fiber.

9. The composite material according to claim 4 wherein the core (10) defines a shape and configuration of a surfboard, a kite-board, or a stand up paddle board.

10. A water sport article comprising a composite material according to claim 1.

11. The composite material according to claim 2 further comprising an adhesive layer 35 impregnate between the glass fiber layer (30 or 30″) and natural fiber layer and/or coconut fiber layer (20).

12. The composite material according to claim 3 wherein the core (10) is a light weight core (10) made of expanded polystyrene or polyurethane or expanded polystyrene composite.

13. The composite material according to claim 3 wherein the multiple layers skin (15) comprising at least a first layer of resin (25), a first layer of glass fiber (30), an adhesive layer (35), a coconut fiber layer (20), a second layer of glass fiber (30″) and a second layer of resin (25″) arrange in a sequence.

14. The composite material according to claim 6 wherein the coconut fiber layer is 1.5-3 mm. thick.

15. A water sport article comprising a composite material according to claim 2.

16. A water sport article comprising a composite material according to claim 3.

17. A water sport article comprising a composite material according to claim 4.

18. A water sport article comprising a composite material according to claim 5.
